(19) United States
(12) Patent Application Publication
(10) Pub. No.: US 2008/0235513 A1
(43) Pub. Date: Sep. 25, 2008

(54) Three Party Authentication

(75) Inventors: David James Foster, Bellevue, WA (US); Thomas G. Phillips, Bellevue, WA (US); James S. Duffus, Seattle, WA (US); David Jaroslav Sebesta, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/687,966

(22) Filed: Mar. 19, 2007

(51) Int. Cl. H04L 9/00

(52) U.S. Cl. 713/185

(57) ABSTRACT

A trust provider uses established relationships with a client device and a server of an e-commerce merchant or service provider to assure the identity of each to the other. The e-commerce merchant can request an encrypted token from the client. The client may use a trust-provider key to generate the encrypted token. The server then passes the token to the trust provider, who only accepts tokens from known, authenticated entities. The trust provider then verifies the token and returns a response to the server. The response may include a client verification for use by the server and an encrypted server verification that is forwarded by the server to the client. In this fashion, both the server and client may be authenticated without prior knowledge of each other.

### BACKGROUND

Online transactions have become a significant portion of overall consumer and corporate financial transactions. Millions of transactions are performed each day for online banking, online shopping, online tax payments, commodity exchanges, etc., having significant monetary value. Projections are for the number of these transactions to not only increase but to increase at an increasing rate. This will be particularly true as the impact of the Internet moves beyond industrialized nations into developing and third world countries.

A significant amount of time and energy has been invested in securing the channel between a consumer and an online provider. Protocols such as SSL2 help to ensure that end-to-end communication is protected from eavesdropping and tampering. However, little success has been realized in the area of endpoint authentication to help ensure that each party in a transaction is who they say they are. Public key infrastructure techniques requiring each party to have a certificate verified by a common certificate authority are cumbersome and either require a common security domain or complicated cross-domain certificates.

In the absence of strong authentication, most online transactions, even those involving significant transfers of money or goods, are typically performed on the basis of a user identifier and password. Oftentimes, user identifiers are simply account numbers that may be copied from in-person transactions completed with checks or a credit card. Passwords are most often selected for the convenience of the user and are simple number combinations or dictionary words that are easily attacked by automated methods. The abundance and success of phishing attacks are testimony to the vulnerability of user identifier/password account access techniques. Once a user identifier and password are compromised, a hacker can impersonate a bona fide user virtually undetected. Further, accounts created with stolen user credentials, such as a Social Security number or a driver's license can create havoc in a person's life including stolen bank funds and a time consuming and costly task to repair his or her credit rating.

### SUMMARY

Endpoint identity can be positively confirmed to help secure transactions of any kind when a securely booted computer is cryptographically associated with a trusted secure service provider that can independently verify the identity of each party in a transaction.

### BRIEF DESCRIPTION OF THE DRAWINGS

FIG. 1 is a simplified and representative block diagram a computer suitable for use with three party identification;

FIG. 2 is a block diagram of a security module found in the computer of FIG. 1;

FIG. 3 is a simplified and representative block diagram of participants in a three party authentication scheme; and

FIG. 4 is flow chart depicting use of three party authentication.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, lit is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

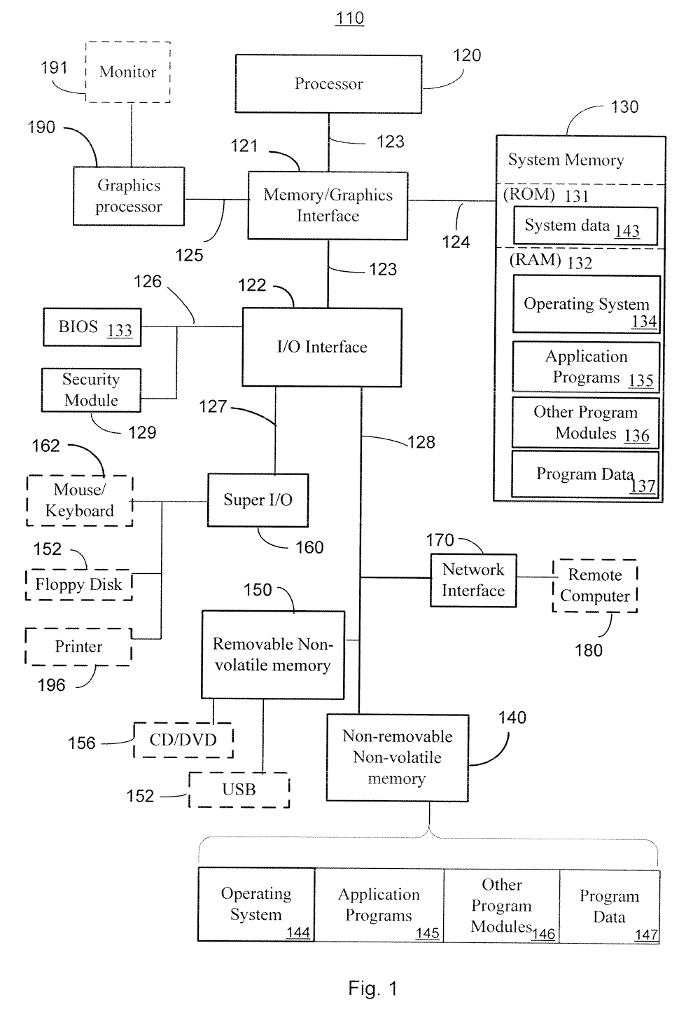

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121, also known as a Northbridge chip, and an I/O interface 122, also known as a Southbridge chip. A memory 130 and a graphics processor 190 may be coupled to the memory/graphics interface 121. A monitor 191 or other graphic output device may be coupled to the graphics processor 190.

A series of system busses may couple various these system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 121 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

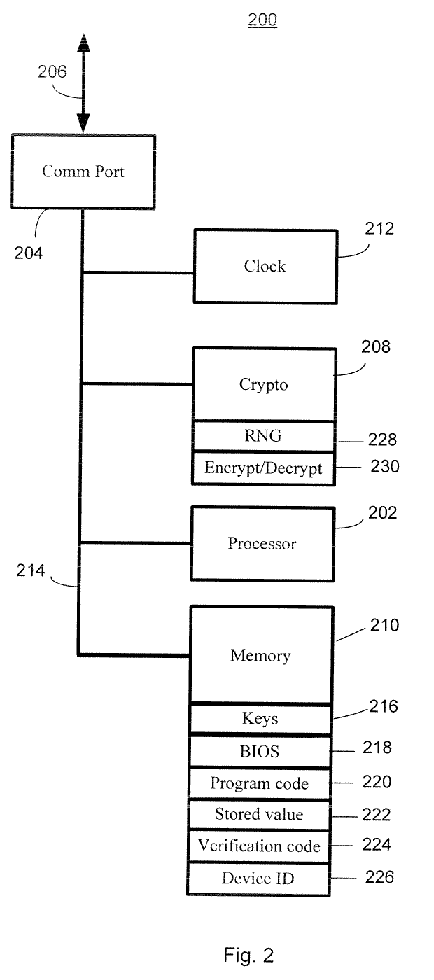

A security module 129 may also be coupled to the I/O controller 122 via the SPI bus 126. In other embodiments, the security module 129 may be connected via any of the other busses available in the computer 110. The security module 129 is discussed in more detail with respect to FIG. 2.

A super input/output chip 160 may be used to connect to a number of ‘legacy’ peripherals, such as floppy disk 152, keyboard/mouse 162, and printer 196, as examples. The super I/O chip 122 may be connected to the I/O interface 121 with a low pin count (LPC) bus, in some embodiments. The super I/O chip is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect—Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 1 illustrates a hard disk drive 140 that reads from or writes to non-removable, nonvolatile magnetic media. Removable media, such as a universal serial bus (USB) memory 152 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processing unit 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170, The remote computer 180 may be a personal computer, a server, a router, a network PC, a peer device or other common network node, and typically includes many or all of the elements described above relative to the computer 110. The logical connection depicted in FIG. 1 may include a local area network (LAN), a wide area network (WAN), or both, but may also include other networks. Such networking environments are commonplace in offices, enterprise-wide computer networks, intranets and the Internet.

In some embodiments, the network interface may use a modem (not depicted) when a broadband connection is not available or is not used. It will be appreciated that the network connection shown is exemplary and other means of establishing a communications link between the computers may be used.

FIG. 2, a simplified and representative block diagram of a security module 200, the same as or similar to the security module 129 of FIG. 1, is discussed and described. The security module 200 may include a processor 202, a communication port 204, a secure memory 210, a cryptographic function 208 and a clock or timer 212. The processor 202 may be a core processor implemented in a custom or so accustomed design, or may be part of a single-chip computer, or may be one component in a multi-chip module (MCM). Communication port 204 may support more than one communication protocol, for example, peripheral component interconnect (PCI/PCIe), low pin count (LPC), or an serial peripheral interconnect (SPI) protocol. In some embodiments, the security module 200 may support multiple communication protocols at once, allowing data traffic with components on more than one bus.

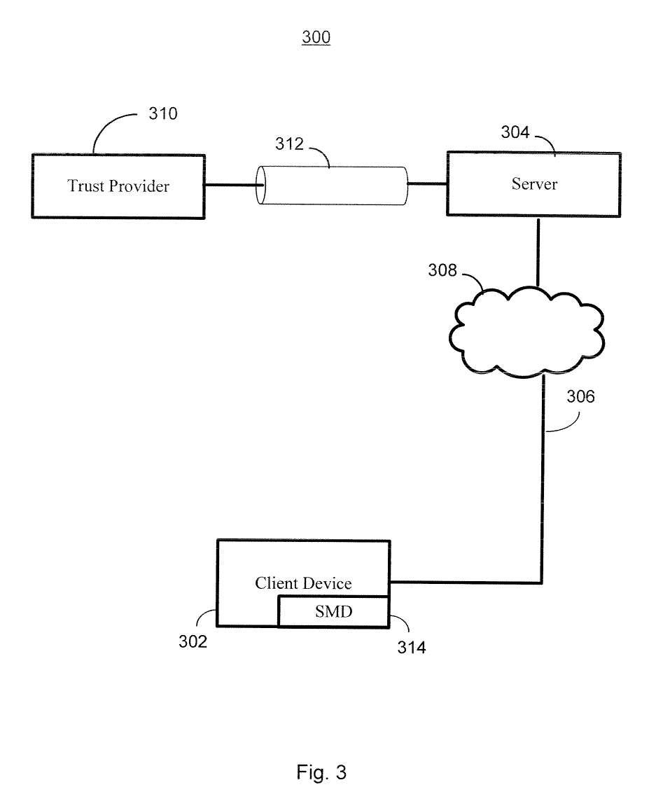

The secure memory 210 may include key memory 418 storing a device master key, derived keys, and transitory session keys. The security module's ultimate master key may be a symmetric key shared with an associated master device, as is discussed in more detail with respect to FIG. 3. A basic input/put system (BIOS) 218 maybe stored in the secure memory 210 and used to boot the computer 110 when more security is required that when booting from an unprotected BIOS, such as BIOS 133 of FIG. 1. Program code 220 may include executable code for managing the operation of the security module 200. Stored value 222 may be used for payment of on-line merchandise or services. In a metered use embodiment, the stored value 222 may represent minutes computer usage or be associated with subscription terms. A verification module 224 may be used in conjunction with the cryptographic module 208 to provide verification of responses from other entities to challenges issued by the security module 200. A device identifier 226 may be securely stored in the memory 210 for use in proof of identity when communicating with an external device.

The cryptographic function 208 may include a random number generator (RNG) 228 and encryption/decryption code 230, for example, a block cipher function. In other embodiments, the cryptographic function 208 may be implemented via a smart chip with full cryptographic capability including public key algorithms, and may communicate with the processor 202 using an ISO 7816 interface.

A clock or timer 212 may be provide tamper resistant time for use in both metering and cryptographic applications, including timeout periods for communications, time stamps for use in secure communications, or in generating a nonce used in message verification. In metered applications, the clock 212 may provide usage timing or subscription expiration periods. The elements of the security module 200 may be connected by an internal bus 214, chosen from any of several known bus technologies, usually associated with the processor 202 type.

In operation, the security module 200 has two significant effects on operation. The first is a provision for secure booting of the computer from a known, protected memory. A U.S. patent application with attorney docket number 30835/319474, filed on the same day as this application, describes an exemplary use of a security module to help ensure booting from a known BIOS. Alter booting from a known BIOS, other known measurements and operations can be taken to help ensure a qualified environment for computer operation. However, other methods of providing a qualified environment for computer operation are known, and others may be contemplated, that do not require booting from a BIOS stored in the security module 200, nor does the three party authentication described herein rely on this capability. The second is a secure base from which to perform mutual authentication with e-commerce providers using, a mutually trusted resource. In the embodiments described here, the mutually trusted partner is the owner of the master key stored in the key area 216 of the secure memory 210.

FIG. 3 is a diagram showing system elements for supporting three party authentication. A client device 302 may be connected to a server 304 via a local connection 306, such as a cable or digital subscriber line modem, to a wide area network 308, such as the Internet. The server 304 may be connected to a trust provider 310 via a secured, mutually authenticated connection 312.

The client device 302 may be similar to the computer 110 of FIG. 1, including the presence of a security module 314, similar to that described with respect to FIG. 2. The client device 302 may be a personal computer or laptop computer, but in other embodiments may be any electronic device capable of supporting a network connection to a service provider, represented by server 304. The electronic device may be a cellular telephone, a personal digital assistant, a smart phone, etc. In most cases, the client device 302 may have a text or graphical user interface for real time interaction with the server 304, but some applications, such as an auction, may not require user intervention to perform meaningful activities on behalf of the user.

The server 304 may be any single computer or group of computers working in concert to support individual transactions requested or authorized via the client device. The server 304 may support sales transactions, such as those offered by an on-line merchant, may support entertainment, such as sporting events, or may support services, such as insurance or banking, to name a few possible applications. Other applications benefiting from strong authentication are arising every day as more people perfonm traditionally ‘brick and mortar’ tasks over via electronic connections, especially the Internet.

The trust provider 310 is an entity that is trusted by both the client device 302 and the server 304, although it is expressed in differing manners. Unlike a certificate authority (CA), the trust provider does not use public key cryptography to create client or server certificates that are later used by the individual parties to confirm identity. Establishing trust using a public key infrastructure (PKI) assumes the CA root key has not been compromised and that each party has a valid user or server certificate from the same CA, and that both parties certificates are not expired, or their private keys compromised. Because of the cost and general unwieldiness of PKI, the vast majority of the e-commerce transactions taking place over the Internet today are authenticated only with a user ID and password.

The trust provider 310 can be used to provide transitory trust between parties without formal mutual authentication between the client device 302 and the server 304. This is possible because of a special relationship between the client device 302 and the trust provider 310 afforded by the security module 314. The client device 302 may be cryptographically bound to the trust provider 310 by way of a shared secret stored at the trust provider 310 and the in security module 314. In one embodiment, the security module 314 is used to provide pay-per-use metering and one function of the security module 314 is to request, authenticate, and store value associated with such metered use. Part of the business model for metered use requires such cryptographic binding to protect an underwriter with a financial interest in client device 302. Should another party be able to provide usage value, the underwriter could be cut out of an expected revenue stream associated with on-going use of the client device.

Whether due to such a metered use business model or not, the security module 314 has a key or key set that may be used to authenticate itself to the trust provider 310. Cryptographically sound initialization and personalization steps should be followed for installation of the keys and identifiers (216 and 226 respectively from FIG. 2), in the security module 314.

Separately, a user may establish a relationship with an on-line provider, represented by server 304. The provider may establish an account on behalf of the user and give the user a standard log-in and password. When the server 304 represents a personal account, such as a bank account, the establishment of such an account may be mandatory. As will be shown below, the establishment of an account is not necessary for the use of the three party identification for some other transaction types.

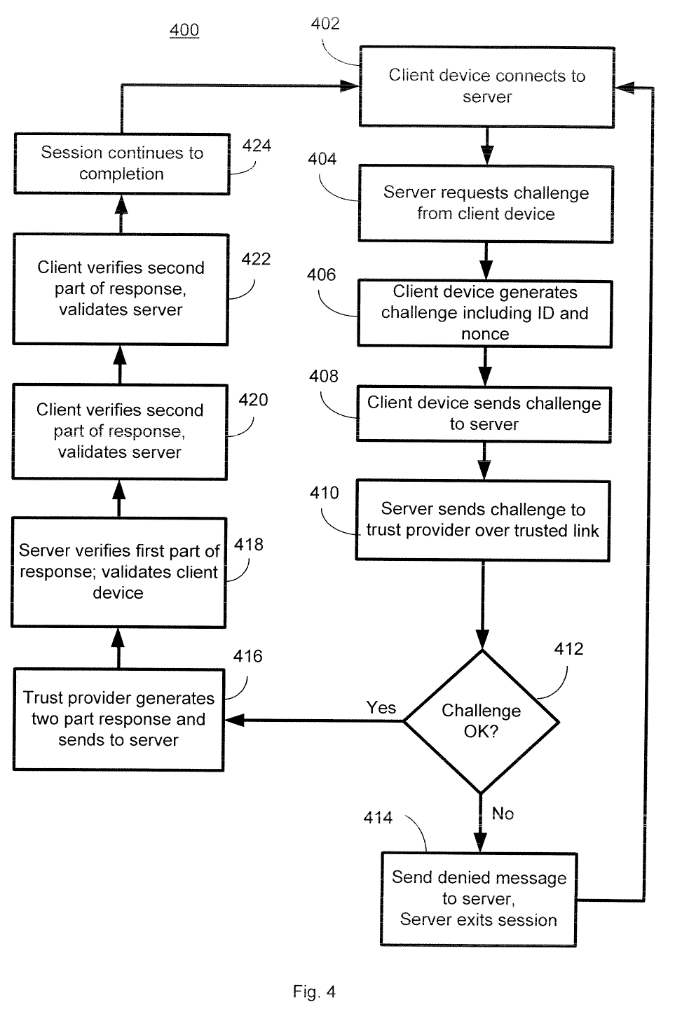

When a provider, represented by server 304, wishes to avail itself of client device authentication, the server 304 may establish a relationship with the trust provider 310. Because the number of potential servers is a small fraction of the number of potential client devices, strong authentication between the server 304 and the trust provider 310 may be established, including, but not limited to, shared secrets, server certificates, or a virtual private network (VPN) over the connection 312. With these conditions in place, that is, shared secrets between the client device 302 and the trust provider 310, a trusted, mutually authenticated link between the server 304 and the trust provider 310, and an optional relationship between the client device's user and the server 304, the method described in FIG. 4 may be used to provide three party authentication.

FIG. 4, a method of providing three party authentication, is discussed and described. As mentioned above, a user of a client device 302 may pre-register with a provider (not depicted) and be given an login ID and password for use in connecting a server 304 associated with the provider. At block 402, the client device 302 may connect with the server 304, preferably over an SSL/SSL2 encrypted channel. After the connection is established, the login ID and password may be used to identify particular account to use for the current transaction. When pre-registration has occurred, the server 304 may have pre-knowledge that the client device 302 has the facilities to support a mutual authentication using a trust provider 310. If no pre-registration has occurred, for example, if the trust provider 310 is expected to provide an identification of the client device 302, the server 304 may query the client device 302 to determine if mutual authentication via the trust provider 310 is supported.

At block 404, after the server 304 has determined that mutual authentication via the trust provider 310 is supported, the server 304 may request a challenge from the client device 302. At block 406, the client device 302 may generate a challenge, or token, using a nonce, such as a random number generated in the security module 314 and a device identifier. The challenge may further include a sequence number, a time stamp, or both to prevent a replay of the current session. The challenge may be encrypted using a secret cryptographic key shared between the client device 302 in the trust provider 310. In many embodiments, a session key may be derived for use in encrypting the challenge to help protect the actual stored key. At block 408, the client device 302 may send the challenge to the server 304.

At block 410, the server 304 may send the challenge to the trust provider 310 over a previously established, trusted link 312, such as a virtual private network. It is assumed that the trusted link 312 involves a high degree of security that may include an out-of-band exchange of secrets or authentication tokens. At block 412, the trust provider 310, using keys shared with the client device 302 may decrypt the challenge received from the server 304 to determine the authenticity of the challenge. Should the decrypting process fail in a client device failed to prove its identity to the trust provider 310, the no branch from bloc 412 may be taken to block 414. A message may be sent to the server 304 that the authentication has failed, at which point, the server may close the session with the client device 302.

When the client device 302 has proven its identity to the trust provider 310, the yes branch from block 412 may be taken to block 416. At block 416, the trust provider 310 may generate a two-part response to the challenge. A first part of the response designated for the server 304, may include a message that the identity of the client device 302 has been verified. To the extent that the identity of the client device 302 is not a secret, the first part of the response may also include the identity of the client device 302. A second part of the response designated for the client device 302, may include the nonce and, in some embodiments, the sequence number. In other embodiments, the second part of the response may also include an identity of the server 304, so the client device 302 can match who the server 304 claims to be with who the trust provider claims the server 304 to be. The second part of the response may be encrypted using the session key but encryption of the second part of the response is not strictly necessary. The response, including both parts, may be sent from the trust provider 310 to the server 304.

At block 418, the server 304 may verify the first part of the response that validates the client device 310. The server 304 may then trust the identity of the client device 302 because of its trust of the trust provider 310 and the quality of the trusted link 312. The server 304 may then forward the response to the client device 302. The server 304 may forward only the second part of the response, since the first part does not pertain to the client device 302.

At block 420, the client device 302 may verify the second part of the response by decrypting, if necessary, and comparing the nonce received with the nonce generated as well as other pertinent information such as verification of the sequence number, when sent. Because the client device 302 has confidence that the challenge was processed by the trust provider 310, and that the trust provider 310 would not process the challenge unless received from a bona fide server, and because the response was received from the server 304, therefore the server 304 can be trusted.

At block 422, because both the server 304 and the client device 302 have received assurances from the trust provider 310 that each other are legitimate, the two may continue their session to completion

Because the mutual authentication process reduces risk for both the server 304 in the client device 302, the trust provider 310 may receive compensation for supporting the transaction. In one embodiment, value 222 stored in the secure memory 210 of the security module 200/314 maybe used to compensate the trust provider 310. Contractual terms between the provider of the server 304 in the trust provider 310 may specify how payment is made by the server 304 for the authentication service, but may include per transaction fees or a percentage of the value transacted.

The methods and apparatus described above for mutual authentication of two parties by a third trusted party benefits both the user of the client device 302 in the provider of the server 304 by allowing mutual authentication virtually in real time between parties to a transaction. Further, because the client device trust base starts in the security module, the client device does not depend on external devices, such as a smart card or software means, for verification that are susceptible to attack or spoofing. The use of the trust provider for mutual authentication is not subject to the issues of expiration and dependence on potentially out of date certificate revocation lists inherent in public key infrastructure. Further, the use of trust provider allows pay-as-you go payment, rather than the advanced purchase of costly and time-limited PKI certificates.

Mutual authentication in this manner does not require the client device and server to be in the same security domain, that is, no cryptographic secrets need to be shared between the two, nor does the trust provider require any knowledge of the nature of the transaction or any account information shared between the client device and the server.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of using a trust provider to provide identity confirmation for a client device and a server device comprising:
booting the client device from a secure module installed in the client device, the secure module having a secure memory storing a boot program used for the booting and a cryptographic secret shared between the client device and the trust provider;
connecting the server device to the trust provider;
establishing a network connection between the client and server devices;
generating a token comprising a nonce, the token encrypted using the cryptographic secret shared with the trust provider;
passing the token from the client device to the server device;
passing the token from the server device to the trust provider;
decrypting the token at the trust provider to verify an identity of the client device;
passing a response token from the trust provider to the server device, the response token including a verification of the identity of the client device;
passing at least a portion of the response token from the server device to the client device, the at least a portion of the response token including the nonce;
verifying the nonce at the client device as a confirmation of a trusted relationship between the server device and the trust provider and confirmation of the server device's authenticity.

2. The method of claim 1, wherein passing the response token from the trust provider to the server device comprises encrypting the at least a portion of the response token including the nonce with the cryptographic secret shared between the client device and the trust provider.

3. The method of claim 2, wherein verifying the nonce at the client device comprises decrypting the at least a portion of the response token using the cryptographic secret shared between the client device and the trust provider.

4. The method of claim 1, further comprising requesting the token from the client device.

5. The method of claim 17 wherein the cryptographic secret shared with the trust provider is a derived symmetric key cryptographic secret shared with the trust provider.

6. The method of claim 1, wherein establishing the network connection between the client and server devices comprises establishing a secure socket level (SSL) connection having an encrypted channel using mutually derived session keys at the client and server devices.

7. The method of claim 1, wherein connecting the server device to the trust provider comprises connecting the server device to the trust provider over a secure connection with mutual authentication.

8. The method of claim 1, further comprising encrypting a first portion of the response token that includes the nonce using the cryptographic secret shared between the client and the trust provider and encrypting a second portion of the response token using a second cryptographic secret shared between the trust provider and the server device.

9. The method of claim 1, further comprising verifying the identity of the client device at the server device by examining the verification of the identity of the client device included in the response token.

10. The method of claim 1, further comprising the client device paying the trust provider for the identity confirmation using a stored value account at the client device.

11. An electronic device arranged and adapted for use in an electronic commerce (e-commerce) environment comprising:
a memory;
a communication device for two way data transmission;
a main processor coupled to the memory and the communication device; and
a security module comprising:
a secure memory storing cryptographic keys associated with a trust provider;a random number generator for generating a nonce;
a second processor coupled to the secure memory and the random number generator; and
a computer-readable medium having computer-executable instructions comprising:
an encryption module that generates a challenge incorporating the nonce and encrypts the challenge using a key associated with one of the cryptographic keys associated with the trust provider, whereby the encrypted challenge is sent to the trust provider via an e-commerce partner coupled through the communication device.

12. The electronic device of claim 11, wherein the computer-readable medium has computer-executable instructions further comprising a decryption module for decrypting an encrypted response to the challenge, the encrypted response generated at the trust provider and received from the e-commerce partner over the communication device.

13. The electronic device of claim 12, wherein the computer-readable medium has computer-executable instructions further comprising a verification module for establishing trust with the e-commerce partner when the decrypted response to the challenge matches at least the nonce.

14. The electronic device of claim 11, wherein the secure module comprises a tamper-resistant clock used to generate the challenge and a secure memory storing at least one basic input/output system (BIOS).

15. A method of validating e-commerce participants at a trust entity comprising:
establishing a mutually authenticated, secure connection between the trust entity and a provider of e-commerce;
receiving from the provider a challenge sent from a client device connected to the provider;
verifying the challenge; and
sending a first confirmation to the provider of the client's identity and a second confirmation to the client for use in establishing trust between the client device and the provider.

16. The method of claim 15, wherein verifying the challenge comprises decrypting the challenge using a key based on a secret shared between the client device and the trust entity.

17. The method of claim 15, further comprising generating a response to the challenge comprising:
generating the first confirmation for use by the provider to confirm the identity of the client device; and
generating the second confirmation for use by the client device to confirm receipt of the challenge by the trust entity.

18. The method of claim 17, wherein generating the second confirmation comprises generating the second confirmation and encrypting the second confirmation with a key based on a secret shared between the client device and the trust entity.

19. The method of claim 17, wherein generating the first confirmation comprises generating the first confirmation and encrypting the second confirmation with a key based on a secret shared between the provider and the trust entity.

20. The method of claim 15, wherein sending the first and second confirmation comprises combining the first and second confirmation into a combined confirmation and sending the combined confirmation to the provider, wherein the provider forwards the second confirmation to the client.
